(19) United States
(12) Patent Application Publication
(10) Pub. No.: US 2024/0024915 A1
(43) Pub. Date: Jan. 25, 2024

(54) FLUIDIZED BED COATING APPARATUS

(71) Applicant: Spraying Systems Co., Wheaton, IL (US)

(72) Inventors: Joseph P. Szczap, Naperville, IL (US); Dominic DeMaria, Clinton Township, MI (US)

(21) Appl. No.: 18/225,873

(22) Filed: Jul. 25, 2023

Related U.S. Application Data
(60) Provisional application No. 63/392,276, filed on Jul. 26, 2022.
(60) Provisional application No. 63/391,991, filed on Jul. 25, 2022.

(51) Int. Cl. B05C 19/02; B05C 19/06

(52) U.S. Cl. CPC B05C 19/02; B05C 19/06

(57) ABSTRACT

A fluidized bed coating system for coating substrate particles with liquid and powder. The system includes a vessel having a particle separating partition that divides an internal chamber of the vessel into up-bed and down-bed regions. An upstanding spray nozzle within the particle separating partition for directing pressurized coating liquid upwardly into the up-bed region such that particles are liquid coated as they circulate through the up-bed and down-bed regions. A coating powder directing system is provided that includes a controller managed powder delivery manifold for directing coating powder and pressurized gas under the particle separating partition and below the discharge orifices of the spray nozzle for coating the liquid coated particles with a uniform thickness of coating powder as they are recirculated through the up-bed and down-bed regions.

### CROSS-REFERENCE TO RELATED APPLICATION

This patent application claims the benefit of No. 63/391,991 to Scrap et al., filed on Jul. 25, 2022 and U.S. Provisional Application No. 63/392,276 to Szczap et al., filed on Jul. 26, 2022 which are incorporated by reference.

### FIELD OF THE INVENTION

The present invention relates generally to fluidized bed coating systems, and more particularly, to fluidized bed coating systems in which particles are covered with a liquid and a powder.

### BACKGROUND OF THE INVENTION

Known fluidized bed coating systems circulate a pressurizing gas through a chamber, usually under a slight vacuum, creating an up-bed region where particles rise and a down-bed region where particles fall. A nozzle sprays the particles with an atomized liquid as they move through the chamber. The liquid dries to create a solid coating on the particles.

It is often desirable to further coat particles in powder. Uniformity of the powder coating can be critical in, for example, the medical, pharmaceutical, and other chemical processing fields. Existing fluidized bed coating systems have been unable to apply powder coatings to particles uniformly.

### OBJECTS AND SUMMARY OF THE INVENTION

It is an object of the invention to provide a fluidized bed coating system adapted to coat particles more effectively with liquid and powder with the liquid and powder drying to form a uniform coating on the particles.

Further advantages of the invention will be apparent upon reviewing the illustrative examples set out in the detailed description with reference to the drawings.

### BRIEF DESCRIPTION OF THE DRAWINGS

FIG. 1 is a diagrammatic vertical section of a Wurster-type fluidized bed coating system in accordance with this invention configured to coat particles with liquid and powder;

FIG. 2 is a diagrammatic depiction of the distribution system for supplying coating powder to the illustrated coating system;

FIG. 3 is an enlarged vertical section of an alternative embodiment of the powder distribution assembly used in the illustrated fluidized bed coating system;

FIG. 4 is a transverse section of one of the powder distribution tubes of the illustrated fluidized bed coating system taken in the plane of line 4-4 in FIG. 3;

FIG. 5 is a transverse section taken in the plane of line 5-5 in FIG. 3; and

FIG. 6 is a depiction of exemplary stages of a substrate particle during the illustrated coating process.

The invention is susceptible to modifications and alternative constructions. Illustrative examples thereof are shown in the drawings and described below in detail. The invention is not limited to the specific examples disclosed. To the contrary, the invention covers all modifications, alternative constructions, and equivalents falling within the spirit and scope of the claims.

### DETAILED DESCRIPTION OF EXEMPLARY EMBODIMENTS

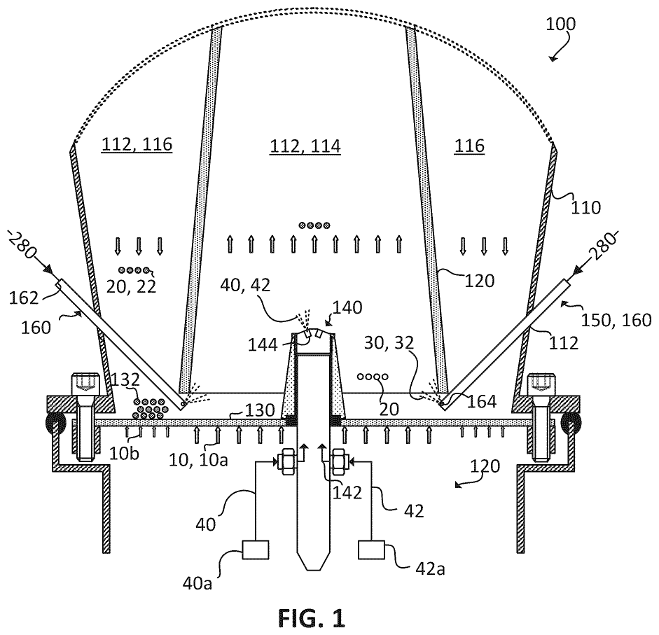

Referring now more particularly to FIG. 1, there is shown are illustrated Wurster-type fluidized bed coating system 100 in accordance with the invention. The coating system 100 includes a bowl or vessel 110 defining a coating chamber 112 in which substrate particles are circulated. A hollow particle separating partition 120 in this case in the shape of a truncated cone divides the chamber 112 into an inner up-bed region 114 and an outer down-bed region 116. As understood by a person skilled in the art, the substrate particles 20 to be coated may be introduced into the coating chamber 112 from an appropriate port in the fluidized bed bowl 110.

Fluidizing gas 10 such as vacuum air enters the chamber 112 and flows through a perforated gas plate 130. The perforations are unevenly distributed across the surface of the perforated gas plate 130 such that the perforated gas plate 130 defines a greater density of perforations below the inner region 114 of the chamber 112 while defining a lesser density of perforations below the outer region 116. The uneven distribution of the perforations in the perforated gas plate 130 causes the fluidizing gas 10 to define an inner higher-velocity region 10a and an outer lower-velocity region 10b.

The higher-velocity fluidizing gas 10a lifts the substrate particles 20 within the up-bed region 114. Eventually, the substrate particles 20 exit the up-bed region 114 through the top of the particle separating partition 120 (not shown) to fall within the down-bed region 116 toward the perforated gas plate 130. The substrate particles 20 collect above the perforated gas plate 130 in a pile 132 that is lightly fluidized by the lower-velocity fluidizing gas 10b before migrating under the particle separating partition 120 and repeating the cycle.

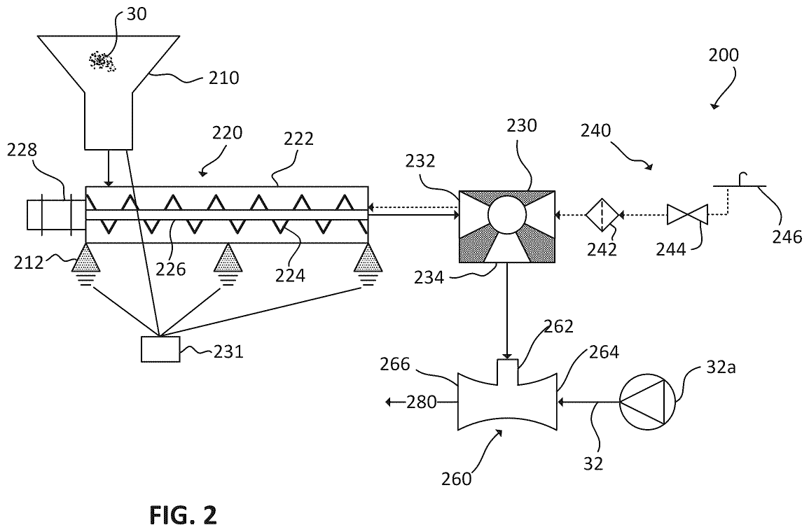

In accordance with an important aspect of the present embodiment, the coating system 100 applies a coating 22 of powder 30 and liquid 40 to the substrate particles 20 as they circulate in the chamber 112 by rising from the lightly fluidized pile 132 into the up-bed region 114 and then falling in the down-bed region 116. The process can be terminated, for example, once a certain mass of powder has been injected into the coating system 100. As will be shown below, this can be estimated by measuring the weight of powder 30 remaining in a powder distribution system with load cells 212 (FIG. 2)

In the illustrated embodiment a nozzle 140 configured to spray a mixture of liquid 40 and pressurizing gas 42 is disposed within the up-bed region 114. The nozzle 140 includes porting 142 connected to a first source 40a (e.g., a tank or a pump) of liquid 40 and a second source 42a (e.g., a tank, a compressor, or a fan) of pressurizing gas 42. The nozzle porting 142 leads to a discharge orifice 144 of the nozzle 140 including one or more discharge orifices 144 from which a mixture of the liquid 40 and the pressurizing gas 42 is sprayed onto the substrate particles 20 rising in the up-bed region 114. The nozzle 140 in this case is an upstanding generally cylindrical structure having one or more discharge orifices 144 in a terminal end.

The liquid 40 can be a solution including one or more coating agents dissolved in a liquid base, such as water. The pressurizing gas 42, like the fluidizing gas 10, can be compressed air. The pressurizing gas 42 atomizes the liquid 40 sprayed from the discharge orifice 144, providing energy to break the stream of liquid 40 into droplets. The liquid 40 mixes with the powder 30 to develop the liquid coating 22 on the outer surface of the substrate particles 20. As further discussed below, the substrate particles 20 can receive a coating of liquid 40 before powder 30 is injected into the coating system 100.

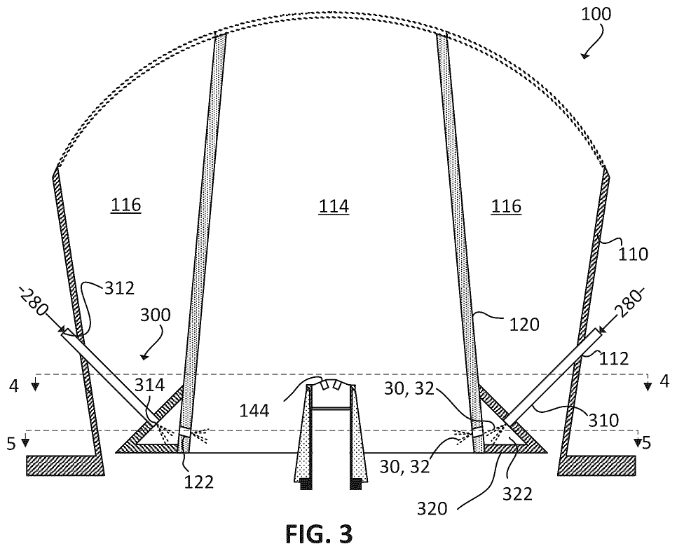

In carrying out this embodiment, a powder distribution assembly 150 is provided that includes one or more powder tubes 160 configured to spray a mixture of powder 30 and pressurizing gas 32 into the up-bed region 114. Each powder directing tube 160 includes an inlet 162 connected to a powder distribution manifold 280 and an outlet 164 configured to direct a mixture of powder 30 and pressurizing gas 32 into the up-bed region 114 (FIG. 3). The powder tube outlet 164 includes one or more outlet ports radially extending with respect to the major axis of the powder tube 160. The ports are configured to spray the mixture of powder 30 and pressurizing gas 32 into the up-bed region 114 at a location below the liquid discharge orifices 144 of the spray nozzle 140. In other examples, the outlet ports of the powder tube outlet 164 are axial with respect to the major axis of the powder tube 160 or horizontal.

Each powder tube 160 in this case fits through a sealed port 112 in the vessel 110. The illustrated powder tubes 160 are slanted downward, placing the tube inlet 162 above the tube outlet 164. The powder tube outlets 164 are located underneath the particle separating partition 120 along an outer perimeter of the higher-velocity fluidizing gas flow 10a.

The powder tube outlets 164 are disposed upstream of the discharge orifices 144 such that the substrate particles 20, during a given cycle, break the plane of the powder tube outlets 164 before breaking the plane of the liquid discharge orifices 144. Once the process reaches a state in which both powder 30 and liquid 40 are injected into the coating system 100, the substrate particles 20 receive powder 30 and atomized liquid 40 effectively at the same time.

The substrate particles 20 preferably are circulated through the fluidized bed coating system 100 while the powder distribution system 150 is offline to receive an initial coating of the liquid 40 from the nozzle 140. Once the coating 22 has attained certain properties (e.g., a measured dew point temperature of the fluidizing gas 10 has reached a predetermined value or a predetermined amount of time has elapsed), the powder distribution system 150 is activated while the nozzle 140 continues to spray liquid 40.

Throughout the process, the mass flow rate of the fluidizing gas 10, 10a, 10b can be increased to overcome the added weight of coating 22 on the substrate particles 20. For example, the mass flow rate of fluidizing gas 10, 10a, 10b can be increased once the powder distribution system 150 comes online.

Examples of substrate particles 20 include seeds, beads, pellets, sugar spheres, pebbles, and minerals. Examples of powder 30 include polymers and pharmaceutical active ingredients. The powder 30 can be designed to adhere to the substrate particles 20. For example, the powder 30 can include a coating agent configured to, upon mixing with the liquid 40, create a chemical bond between the other ingredients of the powder 30 and the substrate particles 20. According to some examples, the properties of the liquid 40 are changed when the powder distribution system 150 is brought online (e.g., a new liquid source 42a is added, an existing liquid source 42a is disconnected, or existing liquid sources 42a are supplied at an updated volume or mass ratio).

FIG. 2 shows a powder distribution system 200 for supplying a mixture of powder 30 and pressurizing gas 32 to the coating system 100 through a powder manifold 280. Powder 30 leaves powder manifold 280 in a dry state. The pressurizing gas 32 (e.g., compressed air) propels powder 30 into the chamber 112 of the coating machine 100.

A hopper 210 funnels dry powder 30 into an auger conveyer 220 having a cylindrical outer housing 222 in which a helical screw blade 224 mounted on a driveshaft 226 is turned by a motor 228. The helical screw blade 224 advances powder 30 toward an intermediate manifold 230. Although shown as a separate element in FIG. 2, manifold 230 can be an outlet of auger conveyer 220.

One or more load cells 212 measure the weight of powder 30 in the hopper 210 and/or the auger conveyer 220. For example, a controller 231 including one or more processors can be configured to subtract a previously measured weight of the auger conveyer 220 and hopper 210 before powder 30 is loaded from a current weight to determine (e.g., estimate) a current weight of the powder 30 remaining within the hopper 210 and/or the auger conveyer 220.

Based on an amount of time between different weight measurements of the remaining powder 30, the controller 231 determines (e.g., estimates) a mass flow rate of powder 30 into the coating system 100. Based on this information, the controller 231 adjusts a speed of auger motor 228 to maintain the current mass flow rate of powder 30 into the coating system 110 (also called a feed rate) at a desired value (e.g., a single value or within an acceptable range of values).

The intermediate manifold 230 is connected to a pressure system 240 including a filter 242 and a pressure sink 246. The pressure system 240 is configured to control the gas pressure within auger conveyer 220 to prevent the eductor from creating a vacuum within the auger housing 222 that would draw extra powder 30 from the hopper 210. For example, if the air pressure within the auger housing 222 is below ambient pressure, then ambient air will flow from the pressure sink 246 (e.g., ambient air), through the filter 242, and into the auger housing 222.

According to some examples, no valves 244 are provided in the pressure relief system 240 such that the interior of the auger housing 222 is in continuous fluid communication with the pressure sink 246 via the filter 242. According to other examples, the pressure relief system 240 includes one or more valves 244 configured to selectively open and close the fluid path between the filter 242 and the pressure sink 246.

The filter 242 is configured to trap powder 30, preventing it from reaching the pressure sink 246. The filter 242 is also configured to trap particles within fluid flowing from the pressure sink 246 (e.g., particles in ambient air), preventing those particles from mixing with the powder 230. The filter 242 is disposed at the top of the manifold/auger outlet 230 and can be, for example, a screen between ambient environment and the auger outlet 230.

Downstream of manifold/conveyer outlet 230, powder 30 enters an ejector 260 through a first inlet port 262. The ejector 260 includes a second inlet port 264 connected to a source 32a of dry pressurizing gas 32, such as a fan, a compressor, or a pressurized gas tank. Eductor 260 can be a jet pump that relies on the venturi effect. The velocity of powder 30 at the outlet 266 of eductor 260 is greater than the velocity of powder at the first inlet 262 of eductor 260. Pressurizing gas 32 pushes powder 30 from eductor outlet 266, through manifold 280, into the powder distribution assembly 150.

FIG. 3 shows a second powder distribution assembly 300 for use in the fluidized bed coating system 100. The second powder distribution assembly 300 can replace the first powder distribution assembly 150 shown in FIG. 1. Alternatively, the first and second powder distribution assemblies 150, 300 can be used in parallel.

The second powder distribution assembly 300 includes one or more powder tubes 310 and a powder distribution ring 320. Each powder tube 310 fits through a sealed port 112 in the vessel 110.

The illustrated powder tubes 310 are slanted downwards such that each tube inlet 312 is disposed above the tube outlet 314. The inlets 312 connect to the powder manifold 280 to receive the mixture of powder 30 and pressurizing gas 32 from the powder distribution system 200. The outlets 314 spray or otherwise deposit the mixture of powder 30 and pressurizing gas 32 into the powder distribution ring 320. Each tube outlet 314 can include one or more outlet ports, which can be, for example, axially or radially oriented with respect to the major axis of the powder tube 310.

The powder distribution ring 320 is welded to the particle separating partition 120 and defines an annular chamber 322. The annular chamber 322 serves as a manifold in which the mixture of powder 30 and pressurizing gas 32 circulate about a circumference of the particle separating partition 120. The powder distribution ring 320 and its annular chamber 322 surround the circumference of the particle separating partition 120.

One or more through holes 122 across the particle separating partition 120 join the annular chamber 322 of the powder distribution ring 320 with the up-bed region 114. The mixture of powder 30 and pressurizing gas 32 circulating within the annular chamber 322 flows from the through holes 122 into the up-bed region 114. The through holes 122 eject or spray the mixture of powder 30 and pressurizing gas 32 into the up-bed region 114 upstream of the discharge orifice 144.

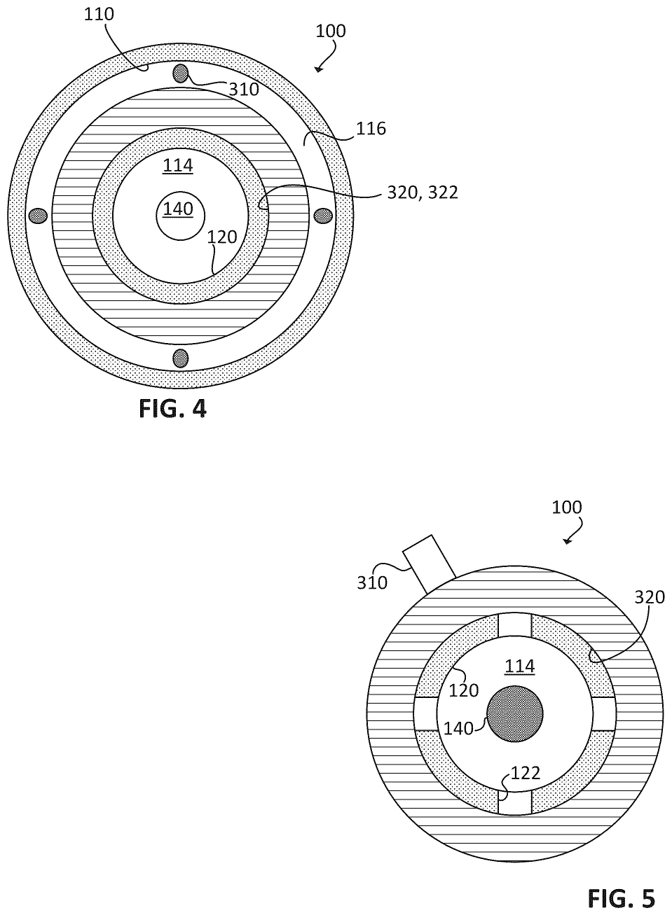

Referring to the cross-sectional plan view in FIG. 4 taken the perspective of section 4-4 in FIG. 3, the second powder distribution assembly 300 defines a ring about the particle separating partition 120. The annular chamber 322 is a circumferentially extending void.

FIG. 5 is a cross-sectional plan view taken from section 5-5 in FIG. 3. A view of a powder tube 310 has been added. Views of the down-bed region 116 and the vessel 110 have been omitted. The through holes 122 are spaced about the circumference of particle separating partition 120. Although not shown, the through holes 122 can be at different vertical heights.

The powder distribution ring 320 enables powder to be sprayed into up-bed region 114 at a number of locations greater than the number of powder tubes 160, enhancing coating uniformity. For example, in FIG. 5, a single powder tube 160 feeds a mixture of powder and pressurizing gas 32 into the annular chamber 322 of the powder distribution ring 320. Four through holes 122 then feed (e.g., spray) powder 30 and the pressurizing gas 32 into the up-bed region 114. In other examples, there are two, four, or eight times more through holes 122 than powder distribution tubes 160. The mass flow rate of powder 30 in each individual powder tube 160 be significantly (e.g., at least 50% or 100%) greater than the mass flow rate of powder 30 through each individual hole 22.

In FIG. 3, the major axis of each through hole 122 is shown as being downwardly inclined with respect to the horizontal. In other examples, the major axis of each through hole 122 is horizontal or upwardly inclined with respect to the horizontal such that the mixture of powder 30 and pressurizing gas 32 is sprayed at the discharge orifices 144 of the nozzle 140.

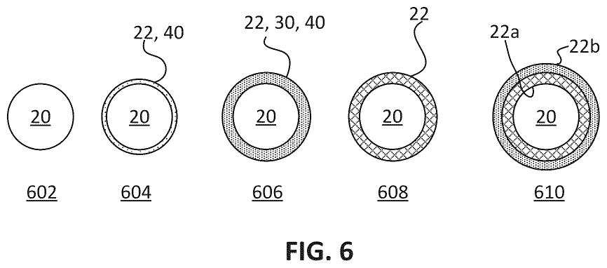

FIG. 6 illustrates stages of a substrate particle 20 and its coating 22 as the substrate particle 20 circulates within fluidized bed coating system 100. The substrate particle begins in a first stage 602 upstream of the discharge orifice 144 and the powder tube outlet 164. Here, the substrate particle 20 is a clean seed such as a pre-coated particle or a raw material. In a second stage 604, atomized liquid 40 sprayed from discharge orifice 144 has formed a wet coating 22 on the outer surface of substrate particle 20. After the second stage 604, the powder distribution assembly 150, 300 is brought online to begin injecting powder 30 into the coating system 100. In a third stage 606, the coating 22 includes a wet mixture of the powder 30 and the liquid 40, including any solid coating agents dissolved in the liquid 40.

After the third stage 606, the coating 22 dries while the substrate particle 20 rises in the up-bed region 114, falls in the down-bed region 116, and rests in the lightly fluidized pile 132. In a fourth stage 608, the substrate particle 20 has a dry coating 22 including solid residue from the powder 30 adhered to the substrate particle 20. The dry coating 22 can also include solid residue from the liquid 40.

After the fourth stage 608, the substrate particle 20 repeats the cycle to build another layer of coating 22. In the fifth stage 610, the substrate particle 20 has a drier inner coating 22a including residue from both the powder 30 and the liquid 40, and a wetter outer coating 22b including a mixture of the powder 30 and the liquid 40. The cycle can be terminated once a certain mass of powder 30 has been dispensed as measured by the load cells 212 of the powder distribution system 200.

Multiple fluidized bed coating systems 100 can be combined into a single assembly. Each of the coating systems 100 in the assembly can define a unique up-bed region 114. The down-bed regions 116 of adjacent coating systems 110 can overlap. Nozzle 140 and coating system 100 can be configured to operate as described in U.S. Publication No. 2008/0000419 to Bender et al. (“Bender”), which is hereby incorporated by reference in its entirety.

While examples have been provided in the drawings and foregoing detailed description, such disclosure is illustrative and exemplary, not restrictive. Changes and modifications may be made to the claims without departing from their spirit and intended scope.

What is claimed:

1. A Wurster-type fluidized bed coating system for coating substrate particles with liquid and powder comprising:
a vessel defining a chamber in which fluidized gas and substrate particles are circulated for coating liquid and powder onto the outer surfaces of circulating particles;
a hollow particle separating partition within said chamber that divides the chamber into an up-bed region inside said particle separating partition and a down-bed region outside said particle separating partition;
a coating liquid spray nozzle supported in upstanding relation within said particle separating partition having at least one discharge orifice adjacent an upper end thereof for spraying a pressurized coating liquid upwardly into said up-bed region such that particles are liquid coated as the particles circulate upwardly through said up-bed region and downwardly through the down-bed region for return circulation into said particle separating partition;
a supply of coating powder and a pressurized gas source; and
at least one powder directing tube coupled to said coating powder supply and pressurized gas source for directing coating powder and pressurized gas into said particle separating partition at a location below the at least one discharge orifice of said spray nozzle for coating liquid coated particles with powder as they are recirculated through said up-bed and down-bed regions.

2. The Wurster-type fluidized bed coating system of claim 1 in which said powder directing tube directs powder into said hollow particle partition from and underside of said particle separating partition.

3. The Wurster-type fluidized bed coating system of claim 1 in which said at least one powder directing tube has an outlet for directing powder and pressurized gas transversally with respect to the axis of the powder directing tube.

4. The Wurster-type fluidized bed coating system of claim 1 in which said at least one powder directing tube has an outlet for directing powder and pressurized gas axially with respect to the major axis of the powder directing tube.

5. The Wurster-type fluidized bed coating system of claim 1 including a plurality of said powder directing tubes for directing coating powder into said particle separating partition at circumferentially spaced locations about said spray nozzle.

6. The Wurster-type fluidized bed coating system of claim 1 in which said at least one powder directing tube communicates with a hollow channel disposed in surrounding relation to said spray nozzle, and said hollow channel being formed with a plurality of discharge orifices for discharging coating powder and pressurized gas into said particle separating partition at circumferentially spaced locations about said spray nozzle.

7. The Wurster-type fluidized bed coating system of claim 1 in which said particles are successively coated with liquid and powder coatings as they are recirculated through the up-bed and down-bed regions until the desired thickness of powder coating is established.

8. The Wurster-type fluidized bed coating system of claim 1 in which said particles are recirculated through said up-bed and down-bed regions sufficient for forming an uniform coating of coating powder on the particles.

9. The Wurster-type fluidized bed coating system of claim 1 in which said supply of coating powder and pressurized gas includes a powder manifold for directing coating powder and pressurized gas to at least one powder directing tube; a hopper containing a supply of coating powder for supply to the powder manifold; and a controller for controlling the supply of coating powder to the powder manifold based upon the weight of the powder in the hopper.

10. The Wurster-type fluidized bed coating system of claim 1 in which said supply of coating powder and pressurized gas includes a powder manifold for directing coating powder and pressurized gas to at least one powder directing tube; a hopper for containing said coating powder; an auger conveyer for directing coating powder from said hopper to the powder manifold; and a controller for controlling the supply of coating powder to the powder manifold based upon the weight of powder transferred by the auger conveyer.

11. The Wurster-type fluidized bed coating system of claim 10 including a gas pressure control system configured to control the gas pressure in the auger conveyer for preventing the creation of a vacuum in the auger conveyer that would draw powder onto the auger conveyer from the hopper.
